(19) United States
(12) Patent Application Publication
(10) Pub. No.: US 2019/0028557 A1
(43) Pub. Date: Jan. 24, 2019

(54) PREDICTIVE HUMAN BEHAVIORAL ANALYSIS OF PSYCHOMETRIC FEATURES ON A COMPUTER NETWORK

(71) Applicants: Ankur MODI, London (GB); Mircea NIL DUMITRESCU, London (GB)

(72) Inventors: Ankur MODI, London (GB); Mircea NIL DUMITRESCU, London (GB)

(21) Appl. No.: 15/756,067

(22) PCT Filed: Aug. 30, 2016
(86) PCT No.: PCT/GB2016/052682

§ 371 Date: Feb. 28, 2018

(30) Foreign Application Priority Data
Aug. 28, 2015 (GB) 1515394.3

(51) Int. Cl. H04L 29/08; H04L 12/26; H04L 29/06; G06F 17/30; G06N 7/00; G06N 3/04

(52) U.S. Cl. CPC H04L 67/22; H04L 43/04; G06N 3/04; G06F 17/30997; G06N 7/005; H04L 63/1425

(57) ABSTRACT

The invention relates to a predictive network behavioural analysis system for a computer network, IT system or infrastructure, or similar. More particularly, the present invention relates to a behavioural analysis system for users of a computer network that incorporates machine learning techniques to predict user behaviour. According to a first aspect, there is provided a method for predicting a change in behaviour by one or more users of one or more monitored computer networks for use with normalised user interaction data, comprising the steps of: identifying from metadata events corresponding to a plurality of user interactions with the monitored computer networks; testing the identified events using one or more learned probabilistic models, each of said learned probabilistic models being related to a behavioural trait and being based on identified patterns of user interactions; and calculating a score using said one or more learned probabilistic models indicating the probability of a change in a behavioural trait of the user.

### FIELD OF THE INVENTION

The invention relates to a predictive network behavioural analysis system for a computer network, IT system or infrastructure, or similar. More particularly, the present invention relates to a behavioural analysis system for users of a computer network that incorporates machine learning techniques to predict user behaviour.

### BACKGROUND

Preventing unauthorised access to computers and computer networks is a major concern for many companies, public bodies, and other organisations. Malicious third parties can cause damage to data and software resulting in large costs to reverse such damage, which may lead to reputational damage and/or even physical damage, where the malicious third parties gain access to IT systems and then steal data, information or software and/or manipulate systems, software or data. As a response to this threat from malicious third parties, a wide variety of countermeasures have been developed, including software and hardware network perimeter security systems, such as firewalls and intrusion detection systems, cryptography and hardware-based two-factor security measures, and an emphasis on ‘security by design.’

All of these countermeasures, however, can fail to adequately respond to the situation where a legitimate user already has access to a computer system or network, and intends to cause damage, and/or steal or manipulate data. This is very difficult to stop because these users are able to plan in secret and then exploit weaknesses in the system. Although human intervention may be able to detect or dissuade users who may represent a threat, paucity of resources in large organisations in particular makes this difficult in practice. Similarly, many users who are concealing other issues and may be on the point of some kind of breakdown are often very difficult to detect in large organisations. Attempts have been made to quantify and predict these harmful events within an organisation; however, it is very difficult to extrapolate this to a user level or to attempt to non-invasively monitor a user's likelihood to engage in a harmful action.

The present invention seeks at least to alleviate partially at least some of the above problems.

### SUMMARY OF INVENTION

Aspects and embodiments are set out in the appended claims. These and other aspects and embodiments are also described herein.

According to a first aspect, there is provided a method for predicting a change in behaviour by one or more users of one or more monitored computer networks for use with normalised user interaction data, comprising the steps of: identifying from metadata events corresponding to a plurality of user interactions with the monitored computer networks; testing the identified events using one or more learned probabilistic models, each of said learned probabilistic models being related to a behavioural trait and being based on identified patterns of user interactions; and calculating a score using said one or more learned probabilistic models indicating the probability of a change in a behavioural trait of the user.

The use of a probabilistic model allows existing users' interactions and patterns of user interactions to be compared against a model of their probable actions, which can be a dynamic model, enabling prediction of excluded events using the monitored computer network or system. A large volume of input data can be used with the method and the model can be based on a variety of data patterns related to excluded events. The use of metadata related to user interactions (as encapsulated in log files, for example, which are typically already generated by devices and/or applications) means that a vast amount of data related to human interaction events can be obtained without needing to provide means to monitor the substantive content of user interactions with the system, which may be intrusive and difficult to set-up due to the volume of data that would then need to be processed. The term ‘metadata’ as used herein can refer to log data and/or log metadata.

Optionally, the method further comprises the step of extracting relevant parameters from the metadata and mapping said relevant parameters to a common data schema, thereby creating normalised user interaction data. Optionally, the method further comprises the step of storing the normalised user interaction event data from the identified events corresponding to a plurality of user interactions with the monitored computer networks.

By creating and/or storing normalised user interaction data the method can process data from multiple disparate sources and having different data structures and variables/fields to assess behaviour and changes in behaviour in users.

Optionally, the identified patterns of user interactions are related to historic user activity prior to the identified events. Optionally, the historic user activity comprises one or more of: individual user historic activity; user peers historic activity and/or interactions with an individual user; historic user group behaviour learned from a plurality of organisations.

The use of real historic data from within the one or more monitored computer networks allows for scenarios leading up to excluded events to be more accurately identified.

Optionally, the method further comprises the step of storing user interaction event data derived from the identified said events corresponding to a plurality of user interactions with the monitored computer networks and updating the one or more learned probabilistic models from said stored user interaction event data.

Updating the probabilistic model based on stored data allows for the model to dynamically adapt to a client system, improving the accuracy of predictions.

Optionally, the method further comprises the step of testing each of said plurality of user interactions with the monitored computer networks against one or more learned probabilistic models further comprises the step of identifying abnormal user interactions.

Identifying abnormal user interactions can provide a further way of measuring behaviour which may be suspicious, which may be used alongside identified patterns of user interactions to improve system accuracy.

Optionally, the user interaction event data comprises any or a combination of: data related to a user involved in an event; data related to an action performed in an event; data related to a device and/or application involved in an event; and/or data related to the time of the event.

Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, the method further comprises the step of storing contextual data, wherein said contextual data is related to a user interaction event and/or any of: a user identity; an action; an object involved in said event; an organisation; an industry; or economic, political or social data that is contextually relevant.

Contextual data, such as information about the user for example as job role and work/usage patterns, can be stored for later use to provide situational insights and assumptions that would not be apparent from the metadata, such as log files, alone. In particular, the contextual data stored can be that determined to be relevant by human and organisational psychology principles, which in turn may be used to explain or contextualise detected behaviours, which can assist to more accurately make predictions.

Optionally, the method further comprises the step of identifying from the metadata events corresponding to a plurality of user interactions further comprises the step of identifying additional parameters by reference to contextual data. Optionally, the contextual data comprises data related to any one or more of: identity data, job roles, psychological profiles, risk ratings, working or usage patterns, action permissibilities, and/or times and dates of events.

Contextual data such as identity data can be used to add additional parameters into data, which can enhance or increase the amount of data available about a particular event.

Optionally, the one or more learned probabilistic models comprise one or more heuristics related to contextual data.

The use of heuristics, for example predetermined heuristics based on psychological principles or insights, can allow for factors that may not be easily quantifiable to be taken into greater account, which can improve recognition of scenarios that may indicate that an excluded event may occur.

Optionally, user interaction event data and contextual data are stored in a graph database.

The use of a graph database can allow for stored data to be updated and modified efficiently and can specifically allow for improved efficiency when storing or querying of relationships between events or other data.

Optionally, the method further comprises the step of storing metadata and/or the relevant parameters therefrom in a search-engine database, relational or document database.

Storing primary data such as the metadata, for example raw logs and/or extracted parameters, can be useful for auditing purposes and allowing checks to be made against any outputs.

Optionally the one or more learned probabilistic models are implemented using a trained machine-learning model. Optionally, the trained machine learning model comprises: a neural network; or an artificial neural network.

The use of trained machine-learning models such as neural networks or artificial neural networks allows the learned probabilistic model to be dynamically trained to carry out the relevant part of the method. Artificial neural networks can be adaptive based on incoming data and can be pre-trained, or trained on an on-going basis, to recognise user behaviours that approximate scenarios leading up to an excluded event.

Optionally, the step of testing each of said plurality of user interactions with the monitored computer networks against one or more learned probabilistic models comprises performing continuous time analysis.

Performing analysis in continuous time (as opposed to discrete time) may allow for relative time differences between user interaction events to be more accurately computed.

Optionally, the method further comprises the step of testing two or more of said plurality of user interactions in combination against said one or more learned probabilistic models. Optionally, the method further comprises the step of determining whether said two or more of the plurality of user interactions are part of an identifiable sequence of user interactions indicating user behaviour in performing an activity.

Testing events in combination allows for single events to be set in the context of related events rather than just historic events. This may provide greater insight, such as by showing that apparently abnormal events are part of a local trend.

Optionally, the time difference between two or more of said plurality of user interactions is tested. Optionally, the time difference is tested against the time difference of related historic user interactions. Optionally, the related historic user interactions comprise interactions associated with at least one of: an individual user; additional users in one or more companies; additional users in one or more groups of users.

Testing the time difference may allow for events to be reliably assembled in their correct sequence. Additionally, distinctive time differences commonly detectable in certain types of event or situations for a particular user or device may be taken into account when predicting excluded events.

Optionally, the method further comprises the step of receiving the metadata from within the one or more monitored computer networks.

Metadata can be received from multiple sources in order to carry out the method with a more comprehensive data set.

Optionally, the step of receiving metadata comprises aggregating metadata at a single entry point.

The use of a single entry point to any system implementing the method minimises the potential for malicious users or third parties tampering with metadata such as log files and lowers latency associated with transmission of metadata, which can improve the time taken to process the metadata.

Optionally, metadata is received at a device via one or more of: a third party server instance; a client server within one or more computer networks; a direct link with the one or more devices; an API service; or simply manually received.

Using any of, a combination of or all of a third party server instance, a client server within one or more computer networks, or a direct link with the one or more devices allows for a variety of different types of metadata to be used, while minimising time associated with metadata transmission.

Optionally, each of the plurality of user interactions with the monitored computer networks are tested substantially immediately following said user interaction event data being identified.

Testing as soon as possible can allow system breaches to be detected with minimal delay, which then allows for alerts to be issued to administrators of the system or for automated actions to be taken to curtail or stop the detected breach.

Optionally, each of the plurality of user interactions with the monitored computer networks are tested according to a predetermined schedule in parallel with other tests. Optionally, testing according to a predetermined schedule comprises analysing all available user interaction data corresponding to a plurality of user interactions with the monitored computer networks, wherein said plurality of user interactions occurred within a predetermined time period. Optionally, the method further comprises the step of classifying calculated scores using one or more predetermined or dynamically calculated thresholds.

Scheduled processing ensures that metadata which is received some time after being generated can be processed in combination with metadata received in substantially real-time, or can be processed with the context of metadata received in substantially real-time, and can be processed taking into account the transmission and processing delay. Processing this later-received metadata can improve detection of malicious behaviour which may not be apparent from processing of solely the substantially real-time metadata.

Optionally, the calculated scores are calculated in additional dependence on one or more correlations between tested user interactions and one or more historic user interactions involving at least one of: the user; a group of users the user is part of or labelled as part of; similar users in one or more organisations; action types; action times; and/or objects involved in the tested user interactions. Optionally, the plurality of user interactions with the monitored computer networks is tested against two or more learned probabilistic models, the results of the two or more probabilistic models being analysed by a further probabilistic model to calculate a further score indicating the probability of the user changing one or more higher level behavioural traits.

Events can be compared with other events in an attempt to find relationships between events, which relationships may indicate a sequence of events leading up to excluded events.

Optionally, the method further comprises reporting or alerting on predicted excluded events or changes in behavioural traits.

Reporting predicted excluded events can be used to alert specific users or groups of users, for example network or system administrators, security personnel or management personnel, about predicted excluded events in substantially real-time or in condensed reports at regular intervals.

Optionally, the method further comprises implementing one or more precautionary measures in response to predicted changes in behavioural traits, said precautionary measures comprising one or more of: issuing a warning, issuing a block on a user or device or a session involving said user or device, suspending one or more user accounts, suspending one or more users' access to certain resources, saving data, and/or performing a custom programmable action. Optionally, the one or more precautionary measures are selected in dependence on the calculated score.

The optional use of precautionary measures allows for automatic and immediate response to any immediately identifiable threats (such as system breaches), which may stop or at least hinder any breaches.

Optionally, the one or more precautionary measures are selected in dependence on detected user response to one or more previously implemented precautionary measures.

Implementing precautionary measures based on confidence and user responses to previously taken actions allows for the responses taken by the system to be escalated, if necessary, to prevent any excluded events from occurring.

Optionally, the timing of the one or more precautionary measures is in dependence on the excluded event.

Timing precautionary measures differently depending on the excluded event allows excluded events to be more likely to be prevented by these measures.

Optionally, the method further comprises receiving feedback related to changes in behaviour traits.

Receiving feedback related to output accuracy can allow for the probabilistic model to adapt in response to feedback, which can improve the accuracy of future outputs.

Optionally, the feedback is weighted in dependence on the type of feedback received.

Weighting feedback may be used to mitigate against operator biases in providing feedback.

Optionally, metadata is extracted from one or more monitored computer networks via one or more of: an application programming interface, a stream from a file server, manual export, application proxy systems, active directory log-in systems, and/or physical data storage.

Using any of, combination of or all of an application programming interface, a stream from a file server, manual export, application proxy systems, active directory log-in systems, and/or physical data storage again allows for a variety of different types of metadata to be used.

Optionally, the method further comprises generating human-readable information relating to user interaction events. Optionally, the method further comprises presenting said information as part of a timeline.

Generating human-readable information, such as metadata, reports or log files, can improve the reporting of malicious behaviour and can allow for more efficient review of any outputs by administrators of a computer network or other personnel.

Optionally, the behavioural trait comprises: an excluded event; a user behavioural change; a user stress level; a user mental state; or a user mistake.

Many behavioural traits can be assessed or predicted.

Optionally, the computer network comprises one or more of: a mobile device; a personal computer; a server; a virtual network; an online service; or an audited online service.

A variety of computer networks can be operable with the method, to allow flexibility in assessing and predicting user behaviour.

According to a second aspect, there is provided apparatus for predicting one or more changes in behavioural traits of one or more users of one or more monitored computer networks, comprising: a data pipeline module configured to identify from the metadata events corresponding to a plurality of user interactions with the monitored computer networks; and an analysis module comprising a trained machine learning model implementing one or more probabilistic models, each of said probabilistic models being related to a behavioural trait and being based on identified patterns of user activity and/or interactions, wherein the analysis module is used to test each of said plurality of user interactions with the monitored computer networks against one or more probabilistic models and calculate a score indicating the probability of the user performing one or more excluded events.

Optionally, there is provided a metadata-ingesting module configured to receive and aggregate metadata from one or more devices within the one or more monitored computer networks.

Optionally, there is provided a user interface accessible via a web portal and/or mobile application.

Optionally, there is provided a transfer module configured to aggregate and send at least a portion of the metadata from the one or more devices within the one or more monitored computer networks, wherein the transfer module is within the one or more monitored computer networks.

Optionally, the data pipeline module is further configured to normalise the plurality of user interactions using a common data schema.

According to a third aspect, there is provided a method for predicting one or more excluded events performed by one or more users of one or more monitored computer networks, comprising the steps of: receiving metadata from one or more devices within the one or more monitored computer networks; identifying from the metadata events corresponding to a plurality of user interactions with the monitored computer networks; storing user interaction event data from the identified said events corresponding to a plurality of user interactions with the monitored computer networks; testing each of said plurality of user interactions with the monitored computer networks against one or more probabilistic models, each of said probabilistic models being related to an excluded event and being based on identified patterns of user interactions; and calculating a score using said one or more probabilistic models indicating the probability of the user performing one or more excluded events.

The use of a probabilistic model allows existing users' actions to be compared against a model of their probable actions, which can be a dynamic model, enabling prediction of excluded events using the monitored computer network or system. A large volume of input data can be used with the method and the model can be based on a variety of data patterns related to excluded events. The use of metadata related to user interactions (as encapsulated in log files, for example, which are typically already generated by devices and/or applications) means that a vast amount of data related to human interaction events can be obtained without needing to provide means to monitor the substantive content of user interactions with the system, which may be intrusive and difficult to set-up due to the volume of data that would then need to be processed. The term ‘metadata’ as used herein can refer to log data and/or log metadata.

Optionally, the identified patterns of user interactions are related to historic user interactions prior to excluded events being performed.

The use of real historic data from within the one or more monitored computer networks allows for scenarios leading up to excluded events to be more accurately identified.

Optionally, the method further comprises storing user interaction event data from the identified said events corresponding to a plurality of user interactions with the monitored computer networks and updating the one or more probabilistic models from said stored user interaction event data.

Updating the probabilistic model based on stored data allows for the model to dynamically adapt to a client system, improving the accuracy of predictions.

Optionally, testing each of said plurality of user interactions with the monitored computer networks against one or more probabilistic models further comprises identifying abnormal user interactions.

Identifying abnormal user interactions can provide a further way of measuring behaviour which may be suspicious, which may be used alongside identified patterns of user interactions to improve system accuracy.

Optionally, said user interaction event data comprises any or a combination of: data related to a user involved in an event; data related to an action performed in an event; and/or data related to a device and/or application involved in an event.

Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, identifying from the metadata events corresponding to a plurality of user interactions with the monitored computer networks comprises extracting relevant parameters from computer and/or network device metadata and mapping said relevant parameters to a common data schema.

Mapping relevant parameters from metadata, for example log files, to or into a common data schema and format can make it possible for this normalised data to be compared more efficiently and/or faster.

Optionally, the method further comprises storing contextual data, wherein said contextual data is related to a user interaction event and/or any of: a user, an action, or an object involved in said event.

Contextual data, such as information about the user for example as job role and work/usage patterns, can be stored for later use to provide situational insights and assumptions that would not be apparent from the metadata, such as log files, alone. In particular, the contextual data stored can be that determined to be relevant by human and organisational psychology principles, which in turn may be used to explain or contextualise detected behaviours, which can assist to more accurately make predictions.

Optionally, identifying from the metadata events corresponding to a plurality of user interactions further comprises identifying additional parameters by reference to contextual data. Optionally, the contextual data comprises data related to any one or more of: identity data, job roles, psychological profiles, risk ratings, working or usage patterns, action permissibilities, and/or times and dates of events.

Contextual data such as identity data can be used to add additional parameters into data, which can enhance or increase the amount of data available about a particular event.

Optionally, the one or more probabilistic models comprise one or more heuristics related to contextual data.

The use of heuristics, for example predetermined heuristics based on psychological principles or insights, can allow for factors that may not be easily quantifiable to be taken into greater account, which can improve recognition of scenarios that may indicate that an excluded event may occur.

Optionally, the one or more probabilistic models are implemented using a trained artificial neural network.

Artificial neural networks can be adaptive based on incoming data and can be pre-trained, or trained on an on-going basis, to recognise user behaviours that approximate scenarios leading up to an excluded event.

Optionally, user interaction event data and contextual data are stored in a graph database.

The use of a graph database can allow for stored data to be updated and modified efficiently and can specifically allow for improved efficiency when storing or querying of relationships between events or other data.

Optionally, the method further comprises storing metadata and/or the relevant parameters therefrom in an index database.

Storing primary data such as the metadata, for example raw logs and/or extracted parameters, can be useful for auditing purposes and allowing checks to be made against any outputs.

Optionally, testing each of said plurality of user interactions with the monitored computer networks against one or more probabilistic models comprises performing continuous time analysis.

Performing analysis in continuous time (as opposed to discrete time) may allow for relative time differences between user interaction events to be more accurately computed.

Optionally, the method further comprises determining whether said two or more of the plurality of user interactions are part of an identifiable sequence of user interactions indicating user behaviour in performing an activity.

Identifying chains of user behaviour may assist in putting events in context, allowing for improved insights about user behaviour to be made.

Optionally, the method further comprises testing two or more of said plurality of user interactions in combination against one or more probabilistic models to identify abnormal user interactions.

Testing events in combination allows for single events to be set in the context of related events rather than just historic events. This may provide greater insight, such as by showing that apparently abnormal events are part of a local trend.

Optionally, the time difference between two or more of said plurality of user interactions is tested. Optionally, the time difference is tested against the time difference of related historic user interactions.

Testing the time difference may allow for events to be reliably assembled in their correct sequence. Additionally, distinctive time differences commonly detectable in certain types of event or situations for a particular user or device may be taken into account when predicting excluded events.

Optionally, receiving metadata comprises aggregating metadata at a single entry point.

The use of a single entry point to any system implementing the method minimises the potential for malicious users or third parties tampering with metadata such as log files and lowers latency associated with transmission of metadata, which can improve the time taken to process the metadata.

Optionally, metadata is received at the device via one or more of a third party server instance, a client server within one or more computer networks, or a direct link with the one or more devices.

Using any of, a combination of or all of a third party server instance, a client server within one or more computer networks, or a direct link with the one or more devices allows for a variety of different types of metadata to be used, while minimising time associated with metadata transmission.

Optionally, each of the plurality of user interactions with the monitored computer networks are tested substantially immediately following said user interaction event data being stored.

Testing as soon as possible can allow system breaches to be detected with minimal delay, which then allows for alerts to be issued to administrators of the system or for automated actions to be taken to curtail or stop the detected breach.

Optionally, each of the plurality of user interactions with the monitored computer networks are tested according to a predetermined schedule in parallel with other tests. Optionally, testing according to a predetermined schedule comprises analysing all available user interaction data corresponding to a plurality of user interactions with the monitored computer networks, wherein said plurality of user interactions occurred within a predetermined time period.

Scheduled processing ensures that metadata which is received some time after being generated can be processed in combination with metadata received in substantially real-time, or can be processed with the context of metadata received in substantially real-time, and can be processed taking into account the transmission and processing delay. Processing this later-received metadata can improve detection of malicious behaviour which may not be apparent from processing of solely the substantially real-time metadata.

Optionally, the method further comprises classifying calculated scores using one or more predetermined or dynamically calculated thresholds. Classification based on thresholds allows for various classes of user interactions to be handled differently in further processing or reporting, improving processing efficiency as a whole and allowing prioritisation to occur.

Optionally, the scores are calculated in additional dependence on one or more correlations between tested user interactions and one or more historic user interactions involving the user, action, and/or object involved in the tested user interactions.

Events can be compared with other events in an attempt to find relationships between events, which relationships may indicate a sequence of events leading up to excluded events.

Optionally, the method further comprises reporting predicted excluded events.

Reporting predicted excluded events can be used to alert specific users or groups of users, for example network or system administrators, security personnel or management personnel, about predicted excluded events in substantially real-time or in condensed reports at regular intervals.

Optionally, the method further comprises implementing one or more precautionary measures in response to one or more predicted excluded events, said precautionary measures comprising one or more of: issuing a warning, issuing a block on a user or device or a session involving said user or device, suspending one or more user accounts, suspending one or more users' access to certain resources, saving data, and/or performing a custom programmable action.

The optional use of precautionary measures allows for automatic and immediate response to any immediately identifiable threats (such as system breaches), which may stop or at least hinder any breaches.

Optionally, the one or more precautionary measures are selected in dependence on the calculated score. Optionally, the one or more precautionary measures are selected in dependence on detected user response to one or more previously implemented precautionary measures.

Implementing precautionary measures based on confidence and user responses to previously taken actions allows for the responses taken by the system to be escalated, if necessary, to prevent any excluded events from occurring.

Optionally, the timing of the one or more precautionary measures is in dependence on the excluded event.

Timing precautionary measures differently depending on the excluded event allows excluded events to be more likely to be prevented by these measures.

Optionally, the method further comprises receiving feedback related to the predicted excluded events.

Receiving feedback related to output accuracy can allow for the probabilistic model to adapt in response to feedback, which can improve the accuracy of future outputs.

Optionally, feedback is weighted in dependence on the type of feedback received.

Weighting feedback may be used to mitigate against operator biases in providing feedback.

Optionally, metadata is extracted from one or more monitored computer networks via one or more of: an application programming interface, a stream from a file server, manual export, application proxy systems, active directory log-in systems, and/or physical data storage.

Using any of, combination of or all of an application programming interface, a stream from a file server, manual export, application proxy systems, active directory log-in systems, and/or physical data storage again allows for a variety of different types of metadata to be used.

Optionally, the method further comprises generating human-readable information relating to user interaction events. Optionally, said information is presented as part of a timeline.

Generating human-readable information, such as metadata, reports or log files, can improve the reporting of malicious behaviour and can allow for more efficient review of any outputs by administrators of a computer network or other personnel.

According to a fourth aspect, there is provided apparatus for predicting one or more excluded events performed by one or more users of one or more monitored computer networks, comprising: a metadata-ingesting module configured to receive and aggregate metadata from one or more devices within the one or more monitored computer networks; a data pipeline module configured to identify from the metadata events corresponding to a plurality of user interactions with the monitored computer networks; and an analysis module comprising a trained artificial neural network implementing one or more probabilistic events, each of said probabilistic models being related to an excluded event and being based on identified patterns of user interactions; wherein the analysis module is used to test each of said plurality of user interactions with the monitored computer networks against one or more probabilistic models and calculate a score indicating the probability of the user performing one or more excluded events.

Apparatus can be provided that can be located within a computer network or system, or which can be provided in a distributed configuration between multiple related computer networks or systems in communication with one another, or alternatively can be provided at another location and in communication with the computer network or system to be monitored, for example in a data centre, virtual system, distributed system or cloud system.

Optionally, the apparatus further comprises a user interface accessible via a web portal and/or mobile application.

Providing a user interface can allow for improved interaction with the operation of the apparatus by relevant personnel along with more efficient monitoring of any outputs from the apparatus.

Optionally, the apparatus further comprises a transfer module configured to aggregate and send at least a portion of the metadata from the one or more devices within the one or more monitored computer networks, wherein the transfer module is within the one or more monitored computer networks.

Providing a transfer module allows for many types of metadata (which are not already directly transmitted to the metadata-ingesting module) to be quickly and easily collated and transmitted to the metadata-ingesting module.

The aspects extend to computer program products comprising software code for carrying out any method as herein described.

The invention extends to methods and/or apparatus substantially as herein described and/or as illustrated with reference to the accompanying drawings.

The invention extends to any novel aspects or features described and/or illustrated herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect may be applied to other aspects, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

The term ‘server’ as used herein should be taken to include local physical servers and public or private cloud servers, or applications running server instances.

The term ‘event’ as used herein should be taken to mean a discrete and detectable user interaction with a system.

The term ‘user’ as used herein should be taken to mean a human interacting with various devices and/or applications within or interacting with a client system, rather than the user of the security provision system, which is denoted herein by the term ‘operator’.

The term ‘behaviour’ as used herein may be taken to refer to a series of events performed by a user.

The terms ‘excluded event’ or ‘excluded action’ as used herein may be taken to refer to any event, series of events, action(s) or behaviour(s) which is predicted by the security provision system and is not desired by the operator of the security provision system.

The term ‘pre-excluded’ as used herein may be taken to refer to any event, series of events, action(s) or behaviour(s) which are not excluded in themselves but indicate that excluded activity (which may be otherwise unrelated to the pre-excluded activity) may be likely to occur.

The term ‘computer network’ as used herein may be taken to refer to any networked computing device, such as: a laptop; a PC; a mobile device; a server; and/or a cloud based computing system. The computer network may be a physical piece of hardware, or a virtual network, or a combination of both.

### BRIEF DESCRIPTION OF THE DRAWINGS

Embodiments will now be described, by way of example only and with reference to the accompanying drawings having like-reference numerals, in which:

FIG. 1 shows a schematic illustration of the structure of a network including a behavioural analysis system;

FIG. 2 shows a schematic illustration of log file aggregation in the network of FIG. 1;

FIG. 3 shows a flow chart illustrating the log normalisation process in a behavioural analysis system;

FIG. 4 shows a schematic diagram of data flows in the behavioural analysis system;

FIG. 5 shows a flow chart illustrating the operation of an analysis engine in the behavioural analysis system; and

FIG. 6 shows a flowchart showing actions that may be taken by the behavioural analysis system based on identified pre-excluded events or behavioural change points.

### SPECIFIC DESCRIPTION

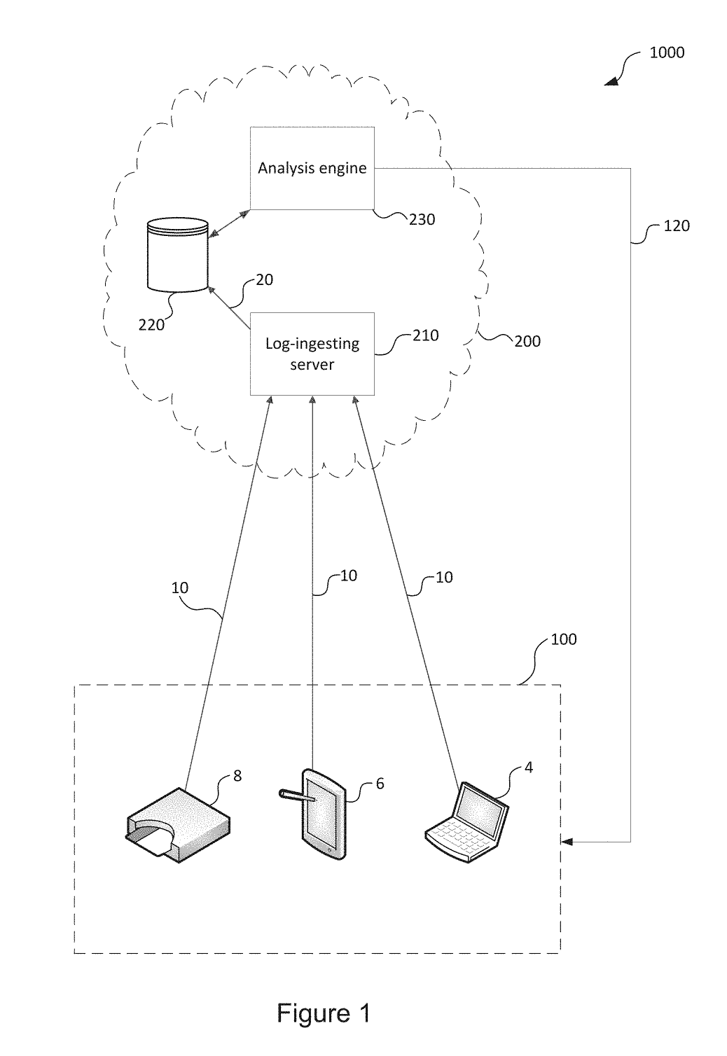

FIG. 1 shows a schematic illustration of the structure of a network 1000 including a security system according to an embodiment.

The network 1000 comprises a client system 100 and a behavioural analysis system 200. The client system 100 is a corporate IT system or network, in which there is communication with and between a variety of user devices 4, 6, such as one or more laptop computer devices 4 and one or more mobile devices 6. These devices 4, 6 may be configured to use a variety of software applications which may, for example, include communication systems, applications, web browsers, and word processors, among many other examples.

Other devices (not shown) that may be present on the client system 100 can include servers, data storage systems, communication devices such as ‘phones and videoconference and desktop workstations, door access systems, lifts, etc. among other devices capable of communicating via a network.

The network may include any of a wired network or wireless network infrastructure, including Ethernet-based computer networking protocols and wireless 802.11x or Bluetooth computer networking protocols, among others.

Other types of computer network or system can be used in other embodiments, including but not limited to mesh networks or mobile data networks or virtual and/or distributed networks provided across different physical networks.

The client system 100 can also include networked physical authentication devices, such as one or more key card or RFID door locks 8, and may include other “smart” devices such as electronic windows, centrally managed central heating systems, biometric authentication systems, or other sensors which measure changes in the physical environment.

All devices 4, 6, 8 and applications hosted upon the devices 4, 6, 8 will be referred to generically as “data sources” for the purposes of this description.

As users interact with the client system 100 using one or more devices 4, 6, 8, metadata relating to these interactions will be generated by the devices 4, 6, 8 and by any network infrastructure used by those devices 4, 6, 8, for example any servers and network switches. The metadata generated by these interactions will differ depending on the application and which device 4, 6, 8 is used.

For example, where a user places a telephone call using a device 8, the generated metadata may include information such as the phone numbers of the parties to the call, the serial numbers of the device or devices used, and the time and duration of the call, among other possible types of information such as bandwidth of the call data and, if the call is a voice over internet call, the points in the network through which the call data was routed as well as the ultimate destination for the call data, call cost, geographical location of the IPs, etc. Metadata is typically saved in a log file 10 that is unique to the device and the application, providing a record of user interactions. The log file 10 may be saved to local memory on the device 4, 6 or 8 or a local or cloud server, or pushed or pulled to a local or cloud server, or both. If for example, the telephone call uses the network to place a voice over internet call, log files 10 will also be saved by the network infrastructure used to connect the users to establish a call as well as any data required to make the call that was requested from or transmitted to a server, for example a server providing billing services, address book functions or network address lookup services for other users of a voice over internet service.

In the network 1000, the log files 10 are exported to the behavioural analysis system 200. It will be appreciated that the log files 10 may be exported via an intermediary entity (which may be within or outside the client system 100) rather than being exported directly from devices 4, 6, 8, as shown in the Figure.

The behavioural analysis system 200 comprises a log-ingesting server 210, a data store 220 (which may comprise a number of databases with different properties so as to better suit various types of data, such as an index (search engine) database (e.g. Elastic Search) 222, a graph database (e.g. Neo4j) 224, for example, a relational database, a document nosql database (e.g. MongoDB) or other databases), and an analysis engine 230.

The log-ingesting server 210 acts to aggregate received log files 10, which originate from the client system 100 and typically the log files 10 will originate from the variety of devices 4, 6, 8 within the client system 100 and so can have a wide variety of formats and parameters. The log-ingesting server 210 then exports the received log files 10 to the data store 220, where they are processed into normalised log files 20.

An embodiment of this normalised log file follows:

```
{
      “_id”: ObjectId(“57b71393aca70b4458ee129e”),
      “source”: {
            “name”: “O365”,
            “type”: “azureActiveDirectoryAccountLogonSchema”,
            “s3File”: “s3FileName.gz”
      },
      “subject”: {
            “id”: ObjectId(“57988ea53e6e6f25b3379270”),
            “type”: “employee”,
            “name”: “John Smith”,
            “location”: {
                  “range”: [
                  2500984832, 2501015551],
                  “country”: “GB”,
                  “region”: “H9”,
                  “city”: “London”,
                  “II”: [
                  51.5144, −0.0941],
                  “metro”: 0,
                  “ip”: “1.2.3.4”
            },
            “extra”: {
                  “UserKey”: “1234567890123@statustoday.com”,
                  “UserType”: {
                        “name”: “Regular”,
                        “description”: “A regular user.”
                  },
                  “UserId”: “john@statustoday.com”,
                  “Client”: “Exchange”,
                  “UserDomain”: “statustoday.com”
            }
      },
      “verb”: {
            “id”: ObjectId(“5798a0131c82ed0100b774c4”),
            “type”: “Other”,
            “name”: “PasswordLogonInitialAuthUsingPassword”,
            “timestamp”: ISODate(“2016-04-16T13:04:35Z”),
            “extra”: {
                  “OrganizationId”: “accd479f-1b29-4fc6-bc4e-e0fab58e7db9”,
                  “RecordType”: 9,
                  “ResultStatus”: “success”,
                  “AzureActiveDirectoryEventType”: 0,
                  “LoginStatus”: 0
            }
      },
      “object”: {
            “id”: ObjectId(“5798a00bdf15ff01006f0c90”),
            “type”: “Account”,
            “name”: “john@statustoday.com”,
            “location”: {
            },
            “extra”: {
                  “Workload”: “AzureActiveDirectory”
            }
      },
      “rawData”: “{\“CreationTime\”:\“2016-04-16T13:04:35\”,\“Id\”:\“1292a9f3-19e8-447d-
a65c-
2dec457299f6\”,\“Operation\”:\“PasswordLogonInitialAuthUsingPassword\”,\“OrganizationId\”:
\“accd479f-1b29-4fc6-bc4e-
e0fab58e7db9\”,\“RecordType\”:9,\“ResultStatus\”:\“success\”,\“UserKey\”:\“1234567890123
@statustoday.com\”,\“UserType\”:0,\“Version\”:\“1.0\”,\“Workload\”:\“AzureActiveDirectory\”,\“
ClientIP\”:\“1.2.3.4\”,\“ObjectId\”:\“john@statustoday.com\”,\“UserId\”:\“john@statustoday.com
\”,\“AzureActiveDirectoryEventType\”:0,\“Client\”:\“Exchange\”,\“LoginStatus\”:0,\“UserDomain
\”:\“statustoday.com\”,\“recommendedParser\”:\“O365ManagementAPIParser\”,\“statusToday
Customer\”:\“575f45a3c77aa5c30f473c35\”}”,
      “meta”: {
            “timestampReceived”: ISODate(“2016-07-27T11:50:33Z”),
            “timestampParsed”: ISODate(“2016-08-19T14:11:31.416Z”),
            “customerId”: ObjectId(“575f45a3c77aa5c30f473c35”),
            “unique”: “1292a9f3-19e8-447d-a65c-2dec457299f6”,
            “shipping”: “api”,
            “shippingData”: {
            }
      }
}
```

The analysis engine 230 compares the normalised log files 20 (providing a measure of present user interactions) to data previously saved in the data store (providing a measure of historic user interactions) and evaluates whether the normalised log files 20 show or indicate that the present user interactions are normal or abnormal, along with comparing recent user interactions against known patterns of user interactions. Such user interactions can include, for example, patterns of behaviour of a particular user, patterns of behaviour of people within the same role, or patterns of behaviour within a user peer group. The analysis engine 230 may then model the probability that a user will perform certain excluded actions. Reports 120 of risks may then be reported back to the client system 100, to a specific user or group of users or as a report document saved on a server or document share on the client system 100. Alternatively or additionally, the alerts may be generated based on the probability of a user performing a certain action, and communicated to the appropriate system for action.

The behavioural analysis system 200, using the above process, is able to provide a probabilistic model to determine whether users' recent patterns of behaviour (as monitored by gathered metadata) indicate a risk that they will perform an excluded action in the near future. It will be appreciated that the behavioural analysis system 200 is configured to be user-centric and operates at a micro level, rather than predicting the occurrence of excluded events at an organisational level.

A number of assumptions are used in the probabilistic model provided by the analysis engine 230 to relate a user's recent actions to potential future excluded actions, as will be described later on. An excluded action may be harmful to the organisation that the user works for or in part of, other organisations, the user themselves, other users, or other people, such as customers, for example. Examples of excluded actions may include stealing data, accessing secured data, resigning, becoming ill, performing illegal activities, and/or harming or attempting to harm themselves or others, among many other potential actions. The invention is not limited to identifying excluded events, but could potentially predict any change in behaviour that might have an impact on the company.

Such changes are not limited to malicious or excluded behaviour, and can include benign behavioural changes as well. These can include behavioural changes relevant to departments within an organisation, such as HR or Operations. Examples include, for example, performance changes, employees about to resign based on significant drop in engagement, accidental edits or emails sent, and/or folder deletions by mistake. This can be extended into predicting higher level behavioural changes and/or events such as employee burnouts, depression, morale, tired traders or rogue traders as well due to the subjective nature of the signals.

All of these fall within the scope of sudden behaviour changes. Predicting these relies on models of patterns of pre-identified employees, for example a known employee or employees who have suffered a burnout or depression. These models can be extrapolated away from just one company, in some embodiments using data from a plurality of companies or organisations, and made more generic.

It will be appreciated that the behavioural analysis system 200 does not require the substantive content, i.e. the raw data generated by the user, of a user's interaction with a system as an input. Instead, the behavioural analysis system 200 uses only metadata relating to the user's interactions, which is typically already gathered by devices 4, 6, 8 on the client system 100. This approach may have the benefit of helping to assuage or prevent any confidentiality and user privacy concerns.

The behavioural analysis system 200 operates independently from the client system 100, and, as long as it is able to normalise each log file 10 received from a device 4, 6, 8 on the client system 100, the behavioural analysis system 200 may be used with many client systems 100 with relatively little bespoke configuration. The behavioural analysis 200 can be cloud-based, which provides for greater flexibility and improved resource usage and scalability.

The behavioural analysis system 200 can be used in a way that is not network intrusive, and does not require physical installation into a local area network or into network adapters. This is advantageous for both security and for ease of set-up, but requires that log files 10 are imported into the system 200 either manually or exported from the client system 100 in real-time or near real-time or in batches at certain time intervals.

Examples of metadata, logging metadata, or log files 10 (these terms can be used interchangeably), include security audit logs created as standard by cloud hosting or infrastructure providers for compliance and forensic monitoring providers. Similar logging metadata or log files are created by many standard on-premises systems, such as SharePoint, Microsoft Exchange, and many security information and event management (SIEM) services. File system logs recording discrete events, such as logons or operations on files, may also be used and these file system logs may be accessible from physically maintained servers or directory services, such as those using Windows Active Directory. Log files 10 may also comprise logs of discrete activities for some applications, such as email clients, gateways or servers, which may, for example, supply information about the identity of the sender of an email and the time at which the email was sent, along with other properties of the email (such as the presence of any attachments and data size). Logs compiled by machine operating systems may also be used, such as Windows event logs, for example as found on desktop computers and laptop computers. Non-standard log files 10, for example those assembled by ‘smart’ devices (as part of an “internet of things” infrastructure, for example) may also be used, typically by collecting them from the platform to which they are synchronised (which may be a cloud platform) rather than, or as well as, direct collection from the device. It will be appreciated that a variety of other kinds of logs can be used in the behavioural analysis system 200.

The log files 10 listed above typically comprise data in a structured format, such as extensible mark-up language (XML), JavaScript object notation (JSON), or comma-separated values (CSV), but may also comprise data in an unstructured format, such as the syslog format for example. Unstructured data may require additional processing, such as natural language processing, in order to define a schema to allow further processing.

The log files 10 may comprise data related to a user (such as an identifier or a name), the associated device or application, a location, an IP address, an event type, parameters related to an event, time, and/or duration. It will, however, be appreciated that log files 10 may vary substantially and so may comprise substantially different data between types of log file 10.

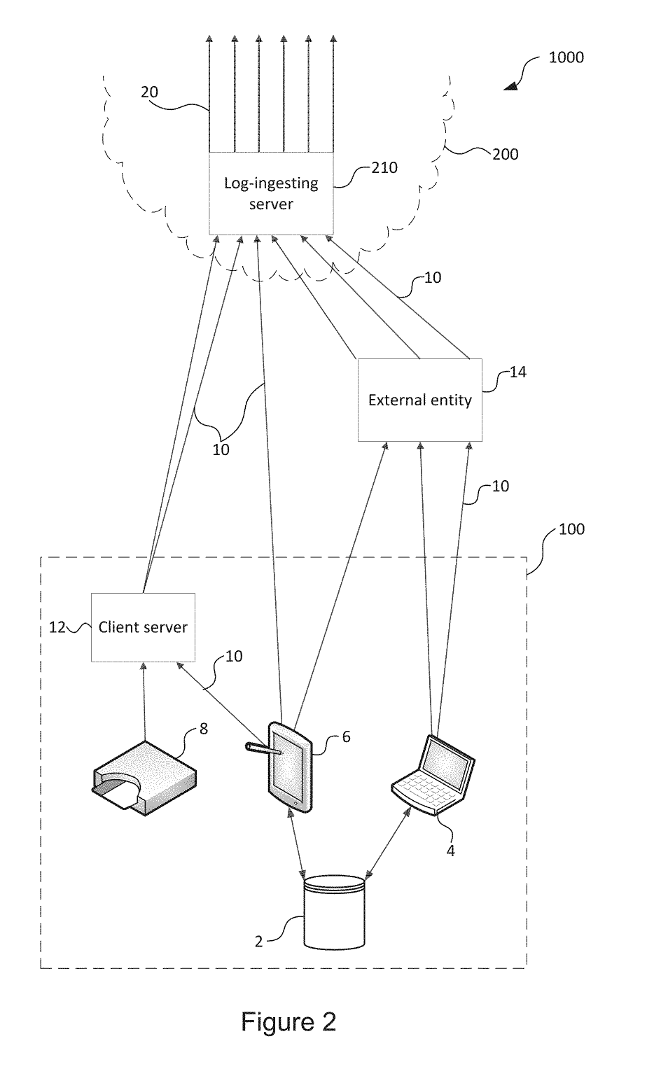

FIG. 2 shows a schematic illustration of log file 10 aggregation in the network 1000 of FIG. 1. As shown in FIG. 2, multiple log files 10 are taken from single devices 4, 6, 8, because each user may use a plurality of applications on each device, thus generating multiple log files 10 per device.

Some devices 4, 6 may also access a data store 2 (which may store secure data, for example), in some embodiments, so log files 10 can be acquired from the data store 2 by the behavioural analysis system 200 directly or via another device 4, 6.

The log files 10 used can be transmitted to the log-ingesting server as close to the time that they are created as possible in order to minimise latency and improve the responsiveness of the behavioural analysis system 200. This also serves to reduce the potential for any tampering with the log files 10, for example to excise log data relating to an unauthorised action within the client system 100 from any log files 10. For some devices, applications or services, a ‘live’ transmission can be configured to continuously transmit one or more data streams of log data to the behavioural analysis system 200 as data is generated. Technical constraints, however, may necessitate that exports of log data occur only at set intervals for some or all devices or applications, transferring batches of log data or log files for the intervening interval since the last log data or log file was transmitted to the behavioural analysis system 200.

Log data 10 may be transmitted by one or more means (which will be described later on) from a central client server 12 which receives log data 10 from various devices. This may avoid the effort and impracticality of installing client software on every single device. Alternatively, client software may be installed on individual workstations if needed. Client systems 100 may comprise SIEM (security information and event management) systems which gather logs from devices and end-user laptops/phones/tablets, etc.

For some devices such as key cards 8 and sensors, the data may be made available by the data sources themselves, as well as by the relevant client servers 12 (e.g. telephony server, card access server) that collect data.

In some cases, one or more log files 10 may be transmitted to or generated by an external entity 14 (such as a third party server) prior to transmission to the behavioural analysis system 200. This external entity 14 may be, for example, a cloud hosting provider, such as SharePoint Online, Office 365, Dropbox, or Google Drive, or a cloud infrastructure provider such as Amazon AWS, Google App Engine, or Azure.

Log files 10 may be transmitted from a client server 12, external entity 14, or device 4, 6, 8 to the log-ingesting server 210 by a variety of means and routes including:
1. an application programming interface (API) for example arranged to push log data to the log-ingesting server 210, or arranged such that log data can be pulled to the log-ingesting server 210, at regular intervals or in response to new log data. Log data 10 may be collected automatically in real time or near-real time as long as the appropriate permissions are in place to allow transfer of this log metadata 10 from the client network 100 to the behavioural analysis system 200. These permissions may, for example, be based on the OAuth standard. Log files 10 may be transmitted to the log-ingesting server 210 directly from a device 4, 6, 8 using a variety of communication protocols. This is typically not possible for sources of log files 10 such as on-premises systems and/or physical sources, which require alternative solutions.
2. file server streams where a physical file is being created. A software-based transfer agent installed inside the client system 100 may be used in this regard. This transfer agent may be used to aggregate log data 10 from many different sources within the client network 100 and securely stream or export the log files 10 or log data 10 to the log-ingesting server 210. This process may involve storing the collected log files 10 and/or log data 10 into one or more log files 10 at regular intervals, whereupon the one or more log files 10 is transmitted to the behavioural analysis system 200. The use of a transfer agent can allow for quasi-live transmission, with a delay of approximately 1 ms-30 s.
3. manual export by an administrator or individual users via a transfer agent.
4. intermediary systems (e.g. application proxy, active directory login systems, or SIEM systems)
5. physical data storage means such as a thumb drive or hard disk or optical disk can be used to transfer data in some cases, for example, where data might be too big to send over slow network connections (e.g. a large volume of historical data).

The log files 10 enter the system via the log-ingesting server 210. The log-ingesting server 210 aggregates all relevant log files 10 at a single point and forwards them on to be transformed into normalised log files 20. This central aggregation (with devices 4, 6, 8 independently interacting with the log-ingesting server 210) reduces the potential for log data being modified by an unauthorised user or changed to remove, add or amend metadata, and preserves the potential for later integrity checks to be made against raw log files 10.

A normalisation process is then used to transform the log files 10 (which may be in various different formats) into generic normalised metadata or log files 20. The normalisation process operates by modelling any human interaction with the client system 100 by breaking it down into discrete events. These events are identified from the content of the log files 10. A schema for each data source used in the network 1000 is defined so that any log file 10 from a known data source in the network 1000 has an identifiable structure, and ‘events’ and other associated parameters (which may, for example, be metadata related to the events) may be easily identified and be transposed into the schema for the normalised log files 20.

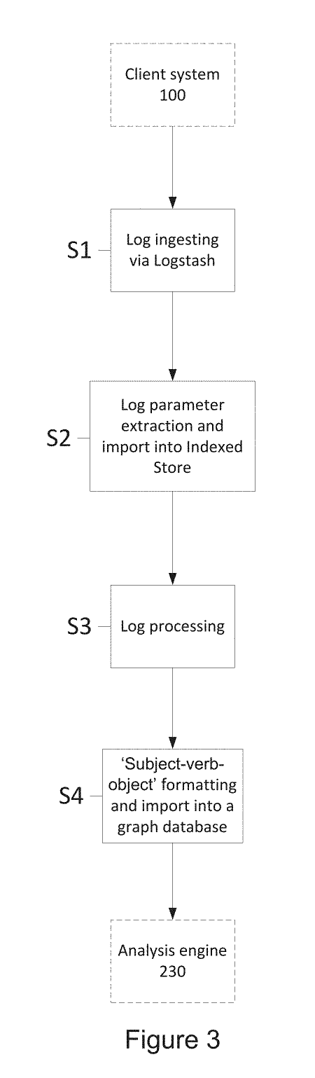

FIG. 3 shows a flow chart illustrating the log normalisation process in a behavioural analysis system 200. The operation may be described as follows (with an accompanying example):

Stage 1 (S1). Log files 10 are received at the log-ingesting server 210 from the client system 100 and are parsed using centralised logging software, such as the Elasticsearch BV “Logstash” software. The centralised logging software can process the log files from multiple hosts/sources to a single destination file storage area in what is termed a “pipeline” process. A pipeline process provides for an efficient, low latency and flexible normalisation process.

An example line of a log file 10 that might be used in the behavioural analysis system 200 and parsed at this stage (S1) may be similar to the following:

L,08/08/12:14:36:02,00D70000000lilT,0057000000IJJB,204.14.239.208,/,,,,“Mozilla/5.0 (Windows NT 6.1; WOW64) AppleWebKit/536.11 (KHTML, like Gecko) Chrome/20.0.1132.57 Safari/536.11”,,,,,,,,

The above example is a line from a log file 10 created by the well-known Salesforce platform, in Salesforce's bespoke event log file format. This example metadata extract records a user authentication, or “log in” event.

Stage 2 (S2). Parameters may then be extracted from the log files 10 using the known schema for the log data from each data source. Regular expressions or the centralised logging software may be used to extract the parameters, although it will be appreciated that a variety of methods may be used to extract parameters. The extracted parameters may then be saved in the index database 222 prior to further processing. Alternatively, or additionally, the parsed log files 10 may also be archived at this stage into the data store 220. In the example shown, the following parameters may be extracted (the precise format shown is merely exemplary):

```
{
      “logRecordType”: “Login”,
      “Date Time”: “08/08/12:14:36:02”,
      “organizationId”: “00D70000000lilT”,
      “userId”: “00570000001IJJB”,
      “IP”: “10.228.68.70”,
      “URI”: “/”,
      “URI Info”: “”,
      “Search Query”: “”,
      “entities”: “”,
      “browserType”: “Mozilla/5.0 (Windows NT 6.1; WOW64)
      AppleWebKit/536.11 (KHTML: like Gecko) Chrome/20.0.1132.57
      Safari/536.11”,
      “clientName”: “”,
      “requestMethod”: “”,
      “methodName”: “”,
      “Dashboard Running User”: “”,
      “msg”: “”,
      “entityName”: “”,
      “rowsProcessed”: “”,
      “Exported Report Metadata”: “”
}
```

Stage 3 (S3). The system 200 may then look up additional data 40 in the data store 220, which may be associated with the user or IDs in the data above, for example, and use the additional data to add new parameters where possible and/or expand or enhance the existing parameters. The new set of parameters or enhanced parameters may then be saved in the index database 222. The additional data 40 may be initialised by a one-time setup for a particular client system 100. The additional data 40 might be also or alternatively be updated directly from directory services such as Windows Active Directory. When new additional data 40 becomes available, previous records can be updated as well with the new additional data 40. The additional data 40 can enable, for example, recognition of two users from two different systems as actually being the same user (“johndoe” on SalesForce is actually “jd” on the local network and “jdoe01@domain.tld” on a separate email system). The same principle applies at a file basis, rather than a user basis: additional data 40 can enable recognition of two data files from different systems as actually being the same file (“summary.docx” on the local server is the same document as “ForBob.docx” on Dropbox).

In the example previously described, the newly processed parameters may be shown as (with new data in bold):

```
{
      “logRecordType”: “Login”,
      “DateTime”: “08/08/12:14:36:02”,
      “organizationId”: “ACME Corp Ltd”,
      “userId”: “jdoe12”,
      “userFirstName”: “Jonathan”,
      “userLastName”: “Doe”,
      “IP”: “204.14.239.208”,
      “location”: {
            “country”: “US”,
            “state”: “CA”,
            “city”: “San Francisco”
      },
      “URI”: “/”,
      “URI Info”: “”,
      “Search Query”: “”,
      “entities”: “”,
      “browserType”: “Mozilla/5.0 (Windows NT 6.1;
      WOW64) AppleWebKit/536.11 (KHTML: like
      Gecko) Chrome/20.0.1132.57 Safari/536.11”,
      “browser”: “Chrome 20”,
      “OS”: “Windows 7”,
      “clientName”: “”,
      “requestMethod”: “”,
      “methodName”: “”,
      “Dashboard Running User”: “”,
      “msg”: “”,
      “entityName”: “”,
      “rowsProcessed”: “”,
      “Exported Report Metadata”: “”
}
```

Stage 4 (S4). To improve later analysis of user interaction with the client system 100 it is necessary to clearly identify events in ‘subject-verb-object’ format, rather than using a set of parameters related to an event as produced by steps S1-S3. At this processing stage the system 200 acts to identify ‘subject-verb-object’ combinations from the processed log data—where a ‘subject’ may comprise data relating to a user and related attributes, a ‘verb’ comprises data related to a particular action or activity together with related attributes, and an ‘object’ comprises data related to a target entity (such as a device or application) together with related attributes.

Arranging relevant data from the example event in a normalised ‘subject-verb-object’ format might take the following form (shown in a table):

| | Subject | Verb | Object |
|---|---|---|---|
| | jdoe12 | login | Salesforce |
| time | | 8th August | |
| | | 12:14:36.02 | |
| userFirstName | Jonathan | | |
| userLastName | Doe | | |
| organisation | Acme Corp Ltd | | |
| location | US/CA/San | | |
| | Francisco | | |
| browser | Chrome 20 | | |
| OS | Windows 7 | | |

In another example, a log may specify: TeamX AdministratorY removed UserZ from GroupT. This can convert into multiple “sentences”: “AdministratorY removed (from GroupT) UserZ” or “UserZ was removed (by AdministratorY) from GroupT”. These statements convey the same information but with various subjects. Typically the schema for ‘subject-verb-object’ combinations is configured on a per log type basis, but a certain degree of automation is possible. Industry standard fields like emails, userid, active directory, date/time etc. can be automatically recognised due to applications following norms and international standards. Implicitly, this means that a class of data sources can potentially have the same schema type and could be handled by simply defining a class schema (e.g. a ‘security information event management’ class schema).

The normalised data can then be formatted in a normalised log file 20 and saved in the graph database 224. The graph database 224 allows efficient queries to be performed on the relationships between data and allows for stored data to be updated, tagged or otherwise modified in a straightforward manner.

The index database 222 may act primarily as a static data store in this case, with the graph database 224 able to request data from the index database 222 and use it to update or enhance the “graph” data in response to queries from the analysis engine 230. The ‘subject-verb-object’ format is represented in a graph database by two nodes (‘subject’ e.g. ‘AdministratorY’ and ‘object’ e.g. ‘UserZ’) with a connection (‘Verb’ e.g. ‘remove’). Parameters are then added to all three entities (e.g. the “remove” action has parameters group and time).

Examples of index databases 22 that may be used include “mongoDB”, “elastic”, but also time series databases like InfluxDB, Druid and TSDB; an example of a graph database 224 that could be used is “neo4j”.

The databases making up the data store 220 are optionally non-SQL databases, which tend to be more flexible and easily scalable. It will be appreciated that the use of data related to log files from many distributed sources across a long time period means that the behavioural analysis system 200 may store and process a very high volume of data.

The normalised log files 20 have a generic schema that may comprise a variety of parameters, which can be nested in the schema. The schema is optionally graph-based. The parameters included will vary to some extent based on the device and/or application that the log files 10 originate from, but the core ‘subject-verb-object’-related parameters are typically consistent across normalised log files 20. Providing a unified generic schema for the normalised log files 20 enables the same schema to be adapted to any source of metadata, including new data sources or new data formats, and allows it to be scaled up to include complex information parameters. The generic schema can be used for ‘incomplete’ data by setting fields as ‘null’. Optionally, these null fields may then be found by reference to additional data 40 or data related to other events. Additionally, the use of a generic schema for the normalised log files 20 and a definition of a schema for the log files originating from a particular data source means that the behavioural analysis system 200 may be said to be system-agnostic, in that, as long as the client system 100 comprises devices 4, 6, 8 which produce log files 10 with a pre-identified schema, the behavioural analysis system 200 can be used with many client systems 100 without further configuration.

It is important that the normalised log files 20 are synchronised as accurately as possible in order for each user interaction with different components/devices/services of the client system 100 to be compared, for example with the benefit of accurate representations of sequences of events. For many applications of the behavioural analysis system 200, analysis of small time gaps between events may be an important factor in identifying abnormal user behaviour. All log files 10 used by the behavioural analysis system 200 should therefore contain timestamp information, allowing the log files 10 to be placed in their proper relative context even when the delays between file generation and receipt at the log-ingesting server 220 differ. The log files 10 may, optionally, be time stamped or re-time stamped at the point of aggregation or at the point at which the normalisation processing occurs in order to compensate for errors in time stamping, for example.

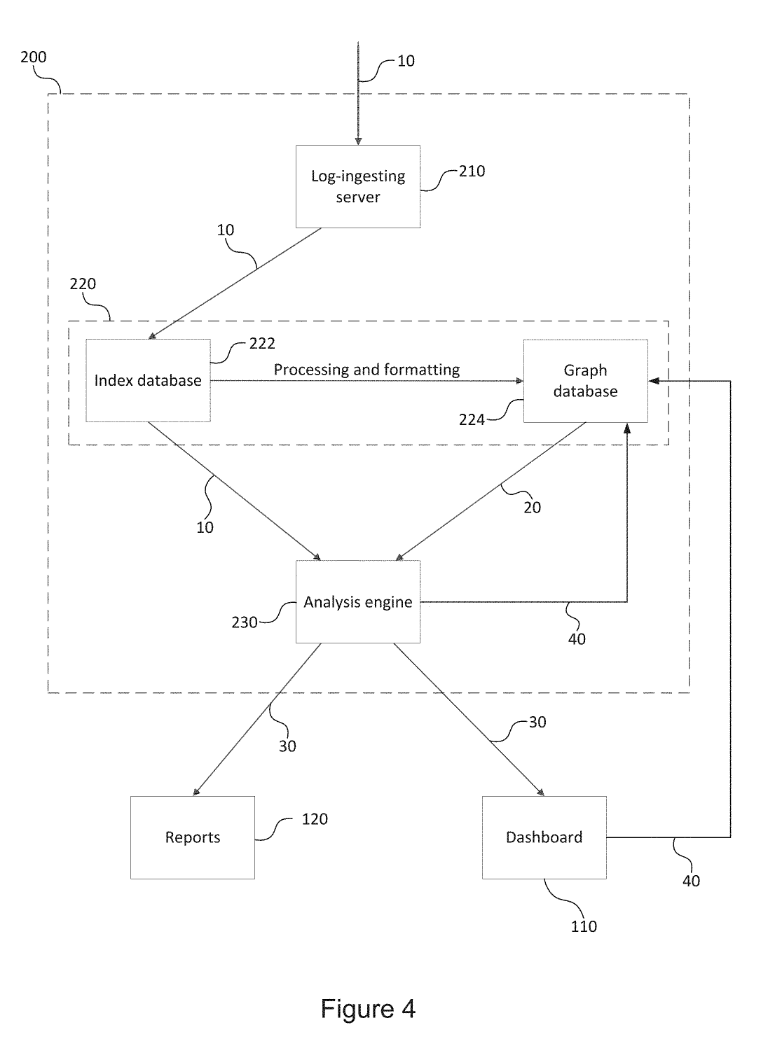

FIG. 4 shows a schematic diagram of data flows in the behavioural analysis system 200. As shown, the analysis engine 230 may receive data (as normalised log files 20) from both the graph database 224 and, optionally, the index database 222, and may produce outputs 30 which may be presented to an administrator via reports 120 or on a ‘dashboard’ web portal or application 110. Outputs 30 may comprise a report on the probability of excluded actions being performed, which may, optionally, be classified based on one or more thresholds—so that an output 30 may be classified as ‘potentially harmful’, ‘likely’ or ‘present danger’ for example. Outputs 30 may also comprise records of any action taken by the behavioural analysis system 200, as will be described later. The other use of these thresholds is to determine whether immediate action is necessary, as will be described later on.

Additional contextual data and/or feedback 40 may be entered by an administrator (or other authorised) user. This contextual data 40 is stored in the data store 220, optionally with the relevant data directly related to events. This contextual data 40 may be generated and saved by the analysis engine 230, as will be described later on, or may be manually input into the data store 220 by an administrator of the client system 100, for example. This contextual data 40 may be associated with a given user, device, application or activity, producing a ‘profile’ which is saved in the data store 220. The contextual data 40 may be based on cues that are largely or wholly non-quantitative, being based on human and organisational psychology. The use of this data 40 allows for complex human factors to be taken into account when predicting a user's behaviour, rather than relying on the event-by-event account supplied by collected log files 10. Contextual data 40 related to a user may comprise, for example, job role, working patterns, personality type, and risk rating (for example, a user who is an administrator may have a higher level of permissions within a client system 100, and so represent a high risk). Other contextual data 40 may include the sensitivity of a document or a set of documents, the typical usage patterns of a workstation or user, or the permissibility of a given application or activity by that user. Many other different factors can be included in this contextual data 40, some of which will be described later on with reference to example excluded activities. The contextual data 40 includes psychology-related data that is integrated into the behavioural analysis system 200 by modelling qualitative studies into chains of possible events/intentions with various probabilities based on parameters like age, gender, cultural background, role in the organisation, and personality type derived from psychometric analysis. Some companies and organisations perform psychometric analysis on their employees to better understand their employees, for example to find potential leaders or just to know which person is preferred/suited to which position. This information can be added to the analysis engine, which can associate the given psychological metrics to the observed behaviour. Some of these metrics/psychological trains can for example be openness, agreeableness and creativity.

The analysis engine 230 is used to identify the probability that a user will undertake an excluded action in the near future based on current/recently received data (corresponding to a user's recent interaction with the system), historic user interaction data, contextual data and a number of identified scenarios which may lead to excluded actions.

The analysis engine 230 may comprise a plurality of algorithms packaged as individual modules. The modules are developed according to machine learning principles which are specialized in modelling a single or a subset of behavioural traits. The modules may be arranged to operate and/or learn on all data sources provided by the normalised log data, or a subset of the data sources. The analysis engine 230 may be arranged to extract certain parameters provided in the normalised log data and provide the parameters to the modules.

The individual modules can be any unsupervised or supervised algorithms, and may use one or more of a plurality of algorithms. The algorithms may incorporate one or more static rules, which may be defined by operator feedback. The algorithms may be based on any combination of simple statistical rules (such as medians, averages, and moving averages), density estimation methods (such as Gaussian mixture models, kernel density estimation), clustering based methods (such as density based, partitioning based, or statistical model based clustering methods, Bayesian clustering, or K-means clustering algorithms), and graph-based methods being arranged to detect social patterns (which may be referred to as social graph analysis), resource access activity, and/or resource importance and relevance (which may be referred to as collaborative filtering). The graph-based methods can be clustered and/or modelled over time. In addition, time series anomaly detection techniques may be used, such as change point statistics or WSARE algorithms (also known as “what's strange about recent events” algorithms). Although the algorithms may be unsupervised, they may be used in combination with supervised models such as neural networks. The supervised neural net may be trained to recognise patterns of events (based on examples, or feedback by the operator) which may indicate that the user is unexpectedly changing their behaviour or marks a long term in their normal behaviour (the saved data relating to a user's normal behaviour may then be updated accordingly). The algorithms as a whole may therefore be referred to as ‘supervised-unsupervised’.

Additionally, the analysis engine 230 comprises a higher layer probabilistic model providing a second layer of statistical learning, which is arranged to combine the outcomes of the individual modules and detect changes at a higher, more abstract, level. This may be used to identify abnormal and/or malicious human interactions with the client system 100. The second layer of statistical learning may be provided by clustering users based on the data produced by the individual modules. Changes in the clusters may be detected, and/or associations can be made between clusters. The change in the data produced by the individual modules may be modelled over time. The data produced by the individual modules may also be dynamically weighted, and/or the data produced by the individual modules may be predicted.

Optionally, the analysis engine 230 may be arranged to pre-process data to be used as an input for the modules. The pre-processing may comprise any of: aggregating or selecting data based on a location associated with the normalised log data or a time at which the data is received and/or generated, determining parameters (such as a ratio of two parameters provided as part of the normalised log data), performing time series modelling on certain parameters provided in the normalised log data (for example, using continuous models such as autoregressive integrated moving average (ARIMA) models and/or discrete models such as string-based action sequences). The pre-processing may be based on the output of one of more of the modules related to a particular parameter, how the output changes over time and/or historic data related to the output.

Analysis based on continuous time (as opposed to discrete time) may be used to analyse probabilities with more accuracy. Continuous time may allow for millisecond/nanosecond differences between actions to be detected. For analysing sequences of events, the relative timing between actions (and not necessarily exact time of day) is important. By analysing the timeline of a sequence of events separated by small amounts of time, chains of actions (corresponding to complex behaviour) can be resolved. Because time is a continuous variable in the continuous time approach, the way questions are asked changes, as follows:
in discrete time, the analysis engine 230 would be able to compute the probability of a user performing an action in a time interval. The probability of this action being performed by the user is equal throughout that slot.
in continuous time, the analysis engine 230 may compute much more precisely exact values for different times, such as one millisecond apart.

In order to calculate values in continuous time, an appropriate model may use differential equations, interpolation and/or other continuous approximation functions.

One of the main problems with machine learning systems is a paucity of data for training purposes; however, the high volume of data collected and saved by the behavioural analysis system 200 means development of an effective algorithm for the analysis engine 230 is possible. If not enough data is available, for example, in the case where new employees (which have a high associated degree of risk) join a business, data from employees similar to them based on role, department, behaviour, etc. can be used as well as pre-modelled psychological traits.

Many indications that a user may soon undertake an excluded action may be cues that are largely or wholly non-quantitative, being based on human and organisational psychology. In addition to using contextual data 40, examples based on these cues may be fed into the analysis engine 230, allowing the analysis engine 230 to take these cues into account when evaluating whether a user's behaviour is suspicious, even if there are no ‘obvious’ signs (in terms of the data that the user accesses, for example) that the user may soon undertake an excluded action.

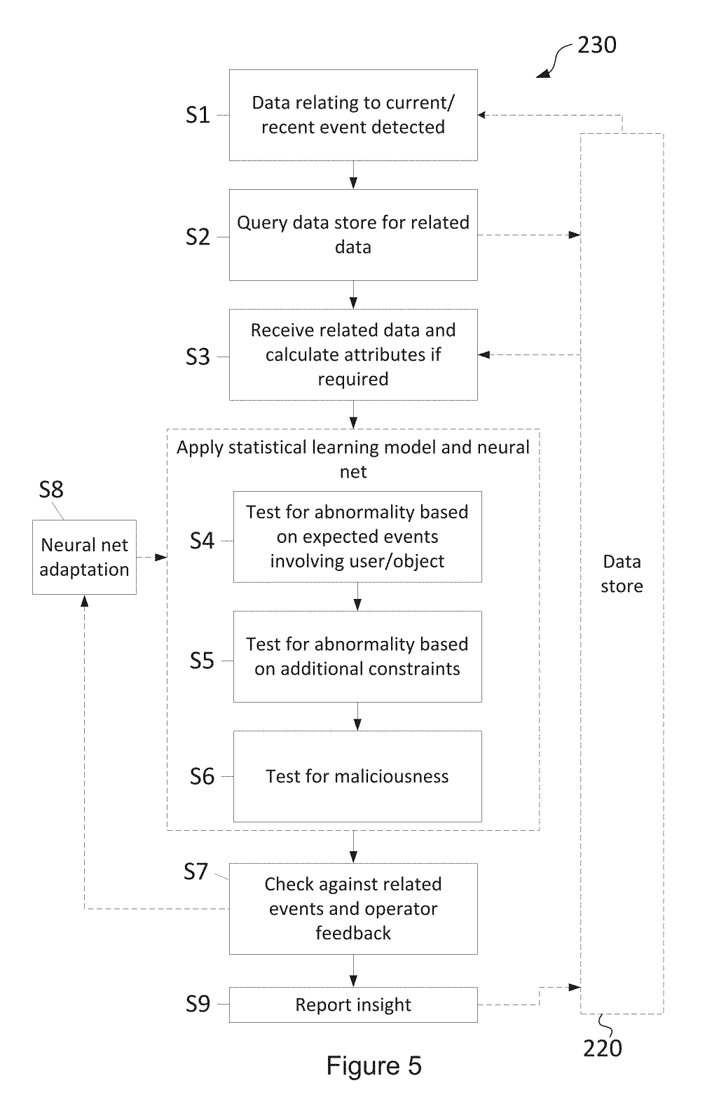

FIG. 5 shows a flow chart illustrating the operation of the analysis engine 230 in the behavioural analysis system 200, where the analysis engine 230 is configured to operate to detect abnormal behaviour and behaviour suggesting that the user may soon undertake an excluded activity. The operation may be described as follows:

Stage 1 (S1). The analysis engine 230 detects that information related to an event is available via the data store 220. This information may comprise normalised log files 20 which have been normalised and pushed into the data store 220 immediately before being detected by the analysis engine 230, but alternatively may relate to less recent data, as will be explained later.

Stage 2 (S2). The analysis engine 230 then may query the data store 220 for related data, in order to set the data relating to the event in context. This related data may comprise both data related to historic events and contextual data 40.

Stage 3 (S3). The related data is received. At this stage a number of attributes may be calculated based on the related data to assist in further processing. Alternatively, previously calculated attributes may be saved in the data store 220, in which case they are recalculated based on any new information. These attributes may relate to the user involved, or may be static attributes related to the event or the object(s) involved in the event. User-related attributes may comprise distributions of activity types by time and/or location or a record of activity over a recent period (such as a 30 day sliding window average of user activity). Static attributes (or semi-static, and changing gradually over time) may comprise the typical number of machines used, the usual number of locations, devices used, browser preferences, and number of flagged events in the past.

Stage 4 (S4). The pattern detection algorithms are then applied to the gathered data. Typically, three discrete tests are performed on the data (see Stage 4, Stage 5 and Stage 6), although the order that they are performed is interchangeable to a certain extent. The tests may be used to produce a score which may be compared against a number of thresholds in order to classify an event or series or events, as mentioned. The first test uses the anomaly detection algorithm and aims to find divergence between the tested event(s) and expected behaviour. A trained model is used to find the probability of the user to be active at the given time and performing the given activity—if it is found that the present event is significantly improbable, this may be a cause to flag the event as abnormal.

The probability of a combination of events occurring, such as a chain of events, is tested alongside the probability of an individual event occurring with help of the second layer of analysis. A score for a combination of events may be produced in a simple case simply by combining the per event scores. New events can be determined to be part of a chain of events by a number of processes, including probability calculations related to the probability that two events occur one after the other and/or probability calculations using continuous time analysis to analyse the time differences between sequential events. Multiple chains of events may be occurring at once, such as when a user is multitasking. Multitasking behaviour can be determined by looking at the range of resources accessed by the user in a short time period (such as if the user is using two different browsers or making a phone call). Multitasking is a behaviour in itself which may indicate that the user is distracted or otherwise agitated, so this may be flagged and used in the analysis engine 230.

Stage 5 (S5). The data is also tested using additional constraints from contextual data 40. This may explain unexpected behaviour, or show that events which are not flagged by the test in Stage 4 are in fact abnormal.

Stage 6 (S6). Pre-excluded behaviour is typically determined differently from the determination of abnormal behaviour, because determining pre-excluded behaviour involves testing events against models of possibly pre-excluded events rather than investigating whether events performed differs from expected events performed. Operator feedback on whether abnormal events were pre-excluded or not is important to improve the models of possibly pre-excluded events, as is described in more detail below. As mentioned above, the analysis engine 230 may be trained based on a variety of different example scenarios. Events (or combinations of events) being analysed by the analysis engine 230 are tested against these scenarios using one or more of correlation, differential source analysis and likelihood calculations, which may be based on user or object history, type of action, events involving the user or object, or other events happening concurrently or close to the same time.

Stage 7 (S7). The volume of data collected and used by the behavioural analysis system 200 and the number of scenarios that could potentially be designated as ‘abnormal’ means that some number of false positive results are expected, particularly as it is expected that many operators of the behavioural analysis system 200 will prefer that the system 200 is sensitive, so as to mitigate the risk of any critical breaches being missed. To mitigate the problem of a high number of false positive results obscuring genuinely pre-excluded behaviour, the analysis engine 230 may perform a ‘sense check’ on any outputs 30 marked as abnormal and/or pre-excluded by re-running calculations and/or testing against previously identified scenarios. A ‘sense check’ can, for example, be an analysis on related events or a department level analysis. In an example, a user has a huge spike in activity, and so is behaving abnormally compared to his history; but if the department as a whole is displaying an activity spike, then the user's behaviour might not be abnormal. Abnormality may be evaluated against the current circumstances or a group of users, not just against historical data.

Stage 8 (S8). Any operator feedback (and, optionally, the results of any ‘sense checks’ based on related events) may be fed back into the learning algorithm, causing the analysis engine to adapt based on feedback. This will be described in more detail later on.

Stage 9 (S9). The results of the analysis engine's calculation and any outputs 30 produced may then be reported to an operator, as will be described later on. The results and/or outputs 30 are also saved into the data store 220.

It will be appreciated that the steps described above are merely an exemplary representation of the operation of the analysis engine 230 according to an embodiment, and alternative processing may be used in other embodiments. In particular, the described steps may be performed out of the described order or simultaneously, at least in part in other embodiments.

For the behavioural analysis system 200 to react quickly to breaches of the client system 100 or other pre-excluded events, the analysis engine 230 needs to act on data that has been collected immediately prior to being received by the analysis engine 230, and optionally also when the data originates from devices that send log files 10 as that are generated. This minimises latency, along with reducing the risk of data being tampered with prior to processing. However, many pre-excluded events are only identifiably pre-excluded in the context of many other events or over a relatively long time scale. In addition, some log files 10 are not sent ‘live’, meaning that many events cannot immediately be set in the context of other events if they are processed as soon as possible after being received by the log-ingesting server 210. In order to account for this data and to correctly find any suspicious ‘long timescale’ events, the analysis engine 230 is used to analyse collected data on a scheduled basis. This occurs in parallel with the analysis engine 230 being used to analyse ‘live’ data as described. Analyses may be made over several different time periods, and may be scheduled accordingly—for example, along with processing ‘live’ data, the analysis engine 230 may analyse data from the last 3 hours once an hour, data from the last 2 days once a day (such as overnight), data from the last month once a week, and so on. Some data might arrive with a delay (e.g. from scheduled or manually shipped logs) and its inclusion might impact the analysis. In order to take later arrived data into consideration, once the log-ingesting server 210 has ingested newly received delayed data, the combined (previously ingested) ‘live’ data and the newly received delayed data is replayed through the analysis engine 230. This way, further abnormal user interactions can be flagged that were not previously identified due to lack of data. This replaying is done in parallel with the live detection until it reaches real-time.

In an example scenario of pre-excluded activity that the behavioural analysis system 200 may be trained to recognise based on a psychological cue, there is typically a distinct and detectable time signature between certain events that is characteristic of a user. For example, this time signature may comprise the average time taken for a user to review a certain kind of document. If this time gradually decreases, it may be a sign that the user is becoming better at this task, or that they are becoming stressed. If these assumptions are true, neither would be cause for great concern. However, if a user suddenly begins to work much faster (as detected by the time signature) this may be a signal that they have suddenly become highly stressed. If this assumption is true, then it may indicate that the user may soon make an excluded action. The real-life reasons for this will of course vary—the user may have received bad news, or they may have been put under duress for example. Distinctive time differences between events which are detectable in certain situations such as that described above may be fed into the analysis engine 230 as input data together with other data related to historic events and contextual data 40.

Detected interactions with elements of one part of the client system 100 may be used by the analysis engine 230 in combination with detected interactions with other elements of the system 100 to produce sophisticated insights and/or to strengthen assumptions about pre-excluded behaviour. For example, in relation to the example described above, if it is detected that the user is taking very long or very short breaks (using both data originating from applications used by the user and by keycard data, which may indicate the user's physical movements in an office) this may be used to strengthen the presumption that the user is stressed. Contextual data may also be useful in explaining scenarios—for example, the behavioural analysis system 200 is provided with contextual data relating to times and dates of performance reviews, the user's sudden onset of stress may be linked to an upcoming or recent performance review. Other assumptions produced from contextual data 40 (such as a user's job) may include that, generally, certain employees (i.e. users) do not work regular hours, while one group users with a certain role may tend to arrive at the office later than other users with another group of job types, and some individual employees tend to take long lunch breaks. A mix of generalisations can be compiled per job type (i.e. user groups), thus allowing for sudden changes of behaviour as compared to colleagues with the same job type to be easily detected.

The association of a ‘profile’ for a given user, device, application or activity allows the analysis engine 230 to detect abnormal behaviour at a high level of granularity, enabling the detection of some potentially suspicious events such as a rarely used workstation experiencing a high level of activity with a rarely used application, or users suddenly starting to do activities that they have never done. As mentioned, additional contextual data 40 may also be used in order that the analysis engine 230 can take account of non-quantitative factors and use them to bias insights about whether abnormal behaviour is pre-excluded. For example, if a contextual data 40 such as a psychological profile is inputted, a user may be characterised as an extrovert. Alternatively, a user may be automatically classified as an extrovert based on factors relating to their outgoing communications to other users, for example. This may then change certain parameter limits for determining whether an activity is suspicious. The behavioural analysis system 200 may then be able to detect whether a user is behaving out of character—for example, if the extrovert in the example above begins working at unsociable times when none of his or her colleagues are in the office, this may be combined with the insight that this behaviour is new to infer that the user's actions may be pre-excluded and should be investigated. Additionally, change points in behaviour may be predicted based on previous actions of the specific user.

Characterising user behaviour which may indicate that the user will undertake an excluded action or a change point in behaviour is a difficult task because in many situations it is only initially detectable that generically ‘something is wrong’ or ‘something will change’, rather than a specific excluded action or behavioural change point being detectable. A notable indicator in this regard is stress, as previously described. Other detectable behaviours which may indicate that ‘something is wrong’ include, for example, agitation, distraction (as detected by the user multitasking or spending only short amounts of time on any activity, for example), erratic behaviour, negligence, or idleness (as detected by a very low number of interactions with documents, for example). These behaviours do not however indicate that a user is likely to undertake an excluded action or behavioural change point on their own. To strengthen the confidence with which predictions about upcoming excluded actions or behavioural change point are made, it is necessary to use a number of assumptions based on contextual and historic data—for example, this might include that users working with valuable information in a highly competitive industry may be strongly tempted to perform an excluded action such as stealing and selling information. This may, optionally, extend to using identified characteristics of a user—for example, if a user is poorly paid, the assumption may be made that they are more likely to be tempted to steal information. Assumptions based on psychological theories are especially powerful in this regard—for example, if a user is low paid relative to other users in his or her job role, it may be assumed that this user is likely to feel poorly treated and may be disproportionately more likely to steal information than a similarly paid user with relatively equal pay to their peers. Using additional data or further assumptions may also enable the specific excluded event or behavioural change point to be identified.

If configured to interface with the client system 100, the behavioural analysis system 200 may be able to make pre-emptive action based on a highly probable excluded event or a detectable change point in the behavioural patterns of an employee which might indicate the onset of higher stress levels. This interface may occur via an API, for example. In an alternative, the behavioural analysis system 200 may suggest actions to be taken to an operator of the client system 100. The actions that the behavioural analysis system 200 may be able to perform may, for example, comprise:
issuing a warning
blocking a user or device
blocking a session involving a user or device
suspending a user account
suspending a user's access to certain resources
freezing user access
safeguarding resources e.g. initiate a system-wide backup.
performing a custom programmable action, such as an API call (this action may be configurable by the operator, and may be used, for example, to cancel an invoice to a third party in dependence on a threat being detected).

These actions may change as the confidence that the user is genuinely about to change behaviour increases. The action taken and the user's response to that action may be fed back into the analysis engine 230, which may increase or decrease the confidence that the user will change behaviour. For example, if, as a result of identified high stress levels, a user is automatically sent a warning that their access to sensitive resources has been restricted and that they should follow up with their security officer (when they would normally be allowed access to these resources), and they attempt to access these resources anyway (via a different application, for example), the confidence that they are intending to perform an excluded action may increase and the situation would be escalated, such as by blocking their account.

The behavioural analysis system 200 may be also be able to issue an alert via email, SMS, phone call or virtual assistant or another communication means.

While the following example is described in relation to individual events, it can also be applied to predict when and if behaviour will start to change based on the detection of certain ‘bigger forces’ occurring at a higher level than just individual events. For example a plurality of individual activity patterns that do not by themselves indicate a change in behaviour may predict that a person would start entering a “stressed-out” phase. This in turn might lead to individual events like security threats or a burnout. Using the combination of individual events, a confidence level about the mental states that the person is in can be determined. This, along with additional activities, can be used to predict the activities or behavioural states that the user might transition into.

Furthermore, different users get tired at different rates, and have different working patterns so individuality has to be modelled. This can be predicted based on current activity, for example a trader, would reach a state of tiredness in X amount of time which could potentially lead to mistakes. The predictions can be based on already observed examples that quantify the amount and severity of potential mistakes.

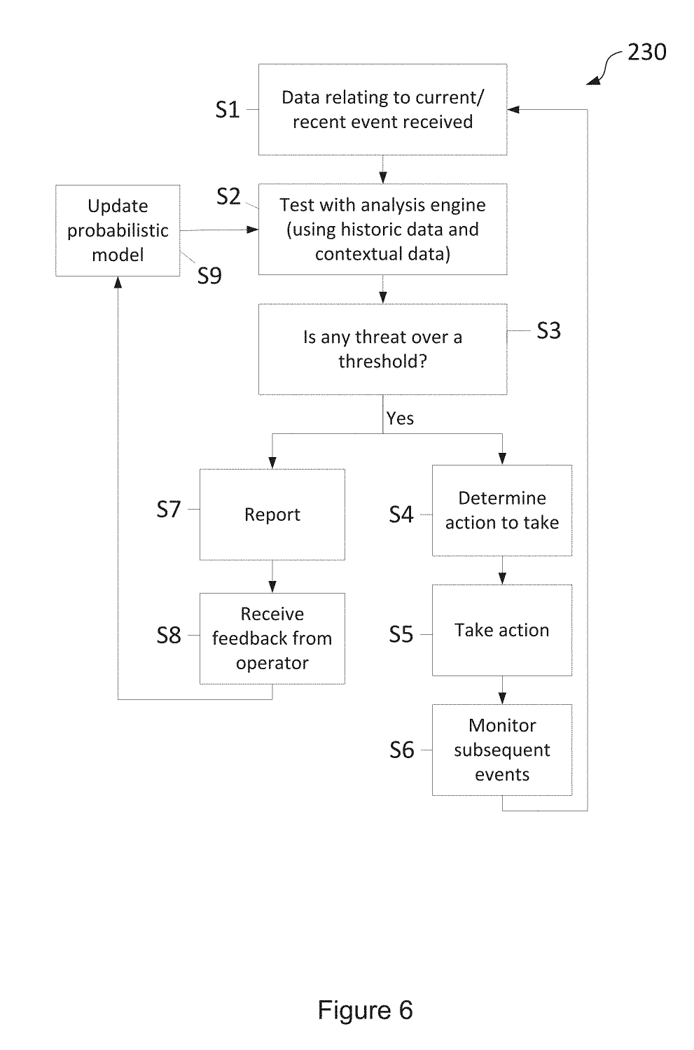

FIG. 6 shows a flowchart showing actions that may be taken by the behavioural analysis system 200 based on identified pre-excluded events. The operation may be described as follows:

Stage 1 (S1): Data related to current/recent events is received.

Stage 2 (S2): Data is analysed in the analysis engine 230, as described with reference to FIG. 5.

Stage 3 (S3): The outputs 30 of the analysis engine are compared against confidence thresholds. A plurality of thresholds may be provided for different excluded actions or behavioural change points, and a plurality of thresholds may be provided per excluded action or behavioural change points. The thresholds used may be absolute thresholds, which are predetermined (by an operator, for example), or relative thresholds, which may relate to a percentage or standard deviation and so require that an exact value for the threshold is calculated on a per-event output 30 basis. The thresholds at which actions occur may be predetermined by the operator or may be dynamically determined based on operator preferences. In many situations, the confidence with which it may be predicted that a user will attempt an excluded action or reach a behavioural change points increases as the user gets closer towards performing that excluded action or reaching the behavioural change points. However, in some cases, it may be less easy to take action which resolves these predicted high-confidence excluded events (where the user is ‘on the brink’ of performing an excluded event), such as where the user has already colluded with others or taken some other action. For this reason, different, dynamically adaptable thresholds can be used for different excluded event, so as to enable any subsequent action to be made at an appropriate time.

An excluded action which is identified as likely to occur may be referred to as a ‘threat’.

Stage 4 (S4): If the threat or predicted behavioural change meets one or more thresholds, the analysis engine 230 may assess a pre-emptive action to be taken. The action selected may, for example, be determined in dependence on the confidence that an excluded action or predicted behavioural change will occur, the potential severity of the excluded event or predicted behavioural change, a characteristic of the user involved, and operator preferences, among many other potential factors.

Stage 5 (S5): The action(s) are performed by the behavioural analysis system 200.

Stage 6 (S6): Subsequent user actions are monitored, and, if necessary, new and more severe actions may be performed by the behavioural analysis system 200.

Stage 7 (S7): Concurrently with S4-S6, threats or predicted behavioural changes exceeding one or more thresholds are reported to an operator. Depending on the potential severity of the threat or predicted behavioural change, this may occur as an urgent alert, or threats/predicted behavioural change may simply be presented on an aggregated report 120 on behaviour which is sent to operators or otherwise accessed occasionally.

Stage 8 (S8): The operator may provide feedback related to the identified prediction (such as, for example, the accuracy and impact of identified predictions) or actions taken in response (such as, for example, marking a response as being unduly harsh). This feedback may, for example, be entered via a web portal or other application.

Stage 9 (S9): The operator's feedback may be fed back into the learning algorithm, causing various parameters and thresholds to change so as to reduce the probability that an event that is not pre-excluded and is similar to a previously marked false positive event is wrongly identified as pre-excluded. The feedbacks provide the necessary data for the unsupervised learning modules to be augmented with supervised ones. For example an unsupervised module might be able to flag an entire group of actions as normal, if the a clustering algorithm would portray these events in a close proximity to the action flagged as normal by the operator. This may comprise using an algorithm to update the parameters for all ‘neurons’ of the supervised neural net. Examples of approaches that could be used in this regard are AdaBoost, BackPropagation, and Ensemble Learning. The supervised neural net is thereby able to adapt based on feedback, improving the accuracy of outputs 30.

It must be taken into account, however, that because of the predictive functionality of the behavioural analysis system 200 it may be difficult to measure the impact of identified threats/behavioural changes or actions taken in response, because the function of the system 200 is to pre-empt and/or manage these events, which may include benign events for which the consequences are unclear. This makes identifying clear successes and failures challenging, particular given possible inherent biases of system operators (for example, an operator may refuse to believe that a co-worker could be planning to steal data, as predicted by the system 200. They may mark this as a false positive, which may reduce to likelihood of the system 200 to detect genuine scenarios of this type in the future). To mitigate this potential problem, the feedback used to update the probabilistic model may be weighted (such that negative feedback causes less adaption than positive feedback, for example). Proper operator training is also vital to ensure that the behavioural analysis system 200 adapts appropriately. The behavioural analysis system 200 may also be able to further process the normalised log files 20 to new logs of events in human-readable format, using the ‘subject-verb-object’ processing described earlier. These new logs can be combined so as to show a user's workflow in the client system 100, and may be produced to show a sequence of events over a certain time period or for a certain user. Optionally, this feature extends to the provision of a unified timeline of a user's actions, or of actions involving an object, incorporating a plurality of new logs of events sorted by time. This feature is useful when conducting an after-event review, or for determining if a series of events is pre-excluded or not, or for producing a record of events that can be used as evidence in a dispute. It may also be used to provide a description 123 of events in a report 120, or to interface with alert systems.

Additionally, the analysis of events in a timeline manner can have other benefits outside the security space such as procedure improvements, personnel reviews, checks of work performed in highly regulated environments etc. Data can be expressed in a number of different ways depending on the detail required or available. With reference to the example described in relation to FIG. 3, this could include:
“Jonathan logged into Salesforce”
“Jonathan logged into Salesforce yesterday at 12:14”
“Jonathan logged into Salesforce yesterday at 12:14 from the Office”
“Jonathan logged into Salesforce yesterday at 12:14 from the Office using Chrome 20 on Windows 7”

The analysis engine 230 may be able to check the last log update from all or any data source, and recognise if latency has increased or if the system has failed. The behavioural analysis system 200 may then issue alerts appropriately.

As described above, a schema is manually defined for each data source to allow log files 10 form that data source to be processed. Alternatively, the functionality of the log-ingesting server 210 may extend to ingesting a file defining a schema for a specific data source, recognising it as such, and then automatically applying this schema to log files 10 received from, that data source.

The behavioural analysis system 200 may be used in combination with or integrate other security solutions, such as encryption systems and document storage systems.

Where data on a client system 100 is of the highest importance, such that cloud systems are not deemed to be sufficiently secure, a ‘local’ version of the behavioural analysis system 200 may be used, in which the behavioural analysis system 200 is integrated within the client system 100.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A method for predicting a change in behaviour by one or more users of one or more monitored computer networks for use with normalised user interaction data, comprising the steps of:
identifying from metadata events corresponding to a plurality of user interactions with the monitored computer networks;
testing the identified events using one or more learned probabilistic models, each of said learned probabilistic models being related to a behavioural trait and being based on identified patterns of user interactions; and
calculating a score using said one or more learned probabilistic models indicating the probability of a change in a behavioural trait of the user.

2. The method of claim 1, further comprising one or more of the following steps:
extracting relevant parameters from the metadata and mapping said relevant parameters to a common data schema, thereby creating normalised user interaction data;
storing the normalised user interaction event data from the identified events corresponding to a plurality of user interactions with the monitored computer networks; and
storing user interaction event data derived from the identified said events corresponding to a plurality of user interactions with the monitored computer networks and updating the one or more learned probabilistic models from said stored user interaction event data.

3. (canceled)

4. The method of claim 1, wherein the identified patterns of user interactions are related to historic user activity prior to the identified events, wherein the historic user activity comprises one or more of: individual user historic activity; user peers historic activity and/or interactions with an individual user; historic user group behaviour learned from a plurality of organisations.

5-6. (canceled)

7. The method of claim 1, wherein the step of testing each of said plurality of user interactions with the monitored computer networks against one or more learned probabilistic models further comprises the step of identifying abnormal user interactions.

8. The method of claim 1, wherein said user interaction event data comprises any or a combination of:
data related to a user involved in an event;
data related to an action performed in an event;
data related to a device and/or application involved in an event; and/or
data related to the time of the event.

9. The method of claim 1, further comprising the step of storing contextual data, wherein said contextual data is related to a user interaction event and/or any of: a user identity; an action; an object involved in said event; an organisation; an industry; or economic, political or social data that is contextually relevant.

10. The method of claim 9, wherein the step of identifying from the metadata events corresponding to a plurality of user interactions further comprises the step of identifying additional parameters by reference to contextual data and/or wherein the one or more learned probabilistic models comprises one or more heuristics related to contextual data.

11-12. (canceled)

13. The method of claim 9, wherein user interaction event data and contextual data are stored in a graph database and/or wherein step of storing metadata and/or the relevant parameters therefrom are stored in a search-engine database, relational or document database.

14. (canceled)

15. The method of claim 1, wherein the one or more learned probabilistic models are implemented using a trained machine-learning model; a neural network; an artificial neural network; and/or continuous time analysis.

16-17. (canceled)

18. The method of claim 1, further comprising the step of testing two or more of said plurality of user interactions in combination against said one or more learned probabilistic models and optionally determining whether said two or more of the plurality of user interactions are part of an identifiable sequence of user interactions indicating user behaviour in performing an activity.

19. (canceled)

20. The method of claim 18, wherein the time difference between two or more of said plurality of user interactions is tested, preferably against the time difference of related historic user interactions, optionally wherein the related historic user interactions comprise interactions associated with at least one of: an individual user; additional users in one or more companies; additional users in one or more groups of users.

21-25. (canceled)

26. The method of claim 1, wherein each of the plurality of user interactions with the monitored computer networks are tested substantially immediately following said user interaction event data being identified or according to a predetermined schedule in parallel with other tests, optionally wherein testing according to a predetermined schedule comprises analysing all available user interaction data corresponding to a plurality of user interactions with the monitored computer networks, wherein said plurality of user interactions occurred within a predetermined time period.

27-28. (canceled)

29. The method of claim 1, further comprising one or more of the following steps:
classifying calculated scores using one or more predetermined or dynamically calculated thresholds
receiving the metadata from within the one or more monitored computer networks and optionally aggregating metadata at a single entry point, preferably wherein metadata is received at a device via one or more of: a third party server instance; a client server within one or more computer networks; a direct link with the one or more devices; an API service; or simply manually received
reporting or alerting on predicted excluded events or changes in behavioural traits;
implementing one or more precautionary measures in response to predicted changes in behavioural traits, said precautionary measures comprising one or more of: issuing a warning, issuing a block on a user or device or a session involving said user or device, suspending one or more user accounts, suspending one or more users' access to certain resources, saving data, and/or performing a custom programmable action, optionally wherein the one or more precautionary measures are selected in dependence on the calculated score, in dependence on detected user response to one or more previously implemented precautionary measures, and/or in dependence on the excluded event;
receiving feedback related to changes in behaviour traits, optionally weighted in dependence on the type of feedback received; and
generating human-readable information relating to user interaction events and optionally presenting said information as part of a timeline.

30. The method of claim 1, wherein the calculated scores are calculated in additional dependence on one or more correlations between tested user interactions and one or more historic user interactions involving at least one of: the user; a group of users the user is part of or labelled as part of; similar users in one or more organisations; action types; action times; and/or objects involved in the tested user interactions.

31. The method of claim 1, wherein the plurality of user interactions with the monitored computer networks is tested against two or more learned probabilistic models, the results of the two or more probabilistic models being analysed by a further probabilistic model to calculate a further score indicating the probability of the user changing one or more higher level behavioural traits.

32-41. (canceled)

42. The method of claim 1, wherein the behavioural trait comprises: an excluded event; a user behavioural change; a user stress level; a user mental state; or a user mistake.

43. The method of claim 1, wherein the computer network comprises one or more of: a mobile device; a personal computer; a server; a virtual network; an online service; or an audited online service.

44. Apparatus for predicting one or more changes in behavioural traits of one or more users of one or more monitored computer networks, comprising:
a data pipeline module configured to identify from the metadata events corresponding to a plurality of user interactions with the monitored computer networks, the data pipeline module optionally being configured to normalise the plurality of user interactions using a common data schema; and
an analysis module comprising a trained machine learning model implementing one or more probabilistic models, each of said probabilistic models being related to a behavioural trait and being based on identified patterns of user activity and/or interactions,
wherein the analysis module is used to test each of said plurality of user interactions with the monitored computer networks against one or more probabilistic models and calculate a score indicating the probability of the user performing one or more excluded events.

45. Apparatus according to claim 44, further comprising one or more of the following:
a metadata-ingesting module configured to receive and aggregate metadata from one or more devices within the one or more monitored computer networks;
a user interface accessible via a web portal and/or mobile application; and
a transfer module configured to aggregate and send at least a portion of the metadata from the one or more devices within the one or more monitored computer networks, wherein the transfer module is within the one or more monitored computer networks.

46-48. (canceled)

49. Apparatus or computer program product comprising software code for carrying out the method of claim 1.

50-92. (canceled)
